(19) United States
(12) Patent Application Publication
(10) Pub. No.: US 2006/0235590 A1
(43) Pub. Date: Oct. 19, 2006

(54) Parking assist utilizing steering system

(76) Inventors: Farhad Bolourchi, Novi, MI (US); Todd D. Brown, Brighton, MI (US); John D. Martens, Chicago, IL (US)

Correspondence Address: DELPHI TECHNOLOGIES, INC., M/C 480-410-202, PO BOX 5052, TROY, MI, 48007, US

(21) Appl. No.: 11/351,980

(22) Filed: Feb. 10, 2006

Related U.S. Application Data
(60) Provisional application No. 60/652,047, filed on Feb. 11, 2005.

(51) Int. Cl. B62D 6/00

(52) U.S. Cl. 701/41

(57) ABSTRACT

The invention may comprise devices and methods for headfirst vehicle parallel parking using front and/or rear wheel steering systems.

### CROSS REFERENCE TO RELATED APPLICATIONS

This application claims priority to U.S. provisional application No. 60/652,047 filed Feb. 11, 2005, the entire contents of which are incorporated herein by reference.

### BACKGROUND

For many drivers, parking a vehicle correctly poses a difficult challenge. Parallel parking in particular can be especially difficult for some drivers. Given the kinematics of the problem and given small tolerance in parking spaces, cars with conventional front wheel steering only are forced to back into a parallel parking space. This “backing up” parking maneuver is more difficult and frustrating than entering headfirst and is also more dangerous due to fact that following traffic must stop well behind the parallel parking space and physically allow the parking vehicle to have room and opportunity to back up which often does not occur. Thus, a system which allows a vehicle to be parallel parked from the headfirst direction is desirable.

An automated parking assist system has been introduced by Toyota® in their 2004 Prius® vehicle. This system utilizes a vision system that displays the available parking spots to the driver. The driver then selects a particular spot and, after positioning the vehicle in the correct staging state, the driver takes his/her hands off the wheel and an electronically controlled steering system turns the front wheels automatically to self-park the vehicle. This pioneering system works well but has several unresolved issues and concerns namely; first, since only the front wheels are steerable, the car must be backed into a spot. Second, the system is totally automatic. While this has its benefits, it typically causes the parking experience to be slow and prone to various diagnostics interrupts. It is also a complex system that may not be appropriate for many vehicles.

### SUMMARY OF THE INVENTION

An embodiment may comprise a controller assisted method for headfirst parallel parking of a vehicle equipped with a steering wheel and four-wheel steering comprising: gathering coordinate data from sensors which indicate the location of the vehicle, the location of an available parallel parking space, and the locations of obstacles; determining via a controller a course that the vehicle should follow in order to parallel park the vehicle in a headfirst forward direction; and controlling via the controller a front steering system of the vehicle and/or a rear steering system of the vehicle so that the steering systems direct front and/or rear wheels to have the vehicle follow the course in a headfirst direction.

An embodiment may also comprise an apparatus for headfirst parallel parking for use with a vehicle equipped with front and rear wheel steering systems comprising sensors for gathering coordinate data which indicate the location of the vehicle, the location of an available parallel parking space, and the locations of obstacles; a controller for determining a course that the vehicle should follow in order to parallel park the vehicle in a headfirst forward direction wherein the controller controls the front and/or rear wheel steering systems of the vehicle so that the steering systems direct the front and/or rear wheels to have the vehicle follow the course determined in a headfirst direction.

An embodiment may also comprise a computer readable medium with instructions thereon which cause a processor in a vehicle having front and rear steering systems to perform: gathering coordinate data from sensors which indicate the location of the vehicle, a location of an available parallel parking space, and locations of obstacles to parking; determining via a controller a course that the vehicle should follow in order to parallel park the vehicle in a headfirst forward direction; and controlling via the controller the front steering system of the vehicle and/or the rear steering system of the vehicle so that the steering systems direct front and/or rear wheels to have the vehicle follow the course in a headfirst direction.

### BRIEF DESCIPTION OF THE FIGURES

Embodiments will now be described, by way of example only, with reference to the accompanying drawings which are meant to be exemplary, not limiting, and wherein like elements are numbered alike in several Figures, in which:

FIG. 1 is a diagram related to a head first vehicle parking maneuver.

FIG. 2 is a diagram related to a “fully automatic” first embodiment head first vehicle parking system with the driver's “hands off.”

FIG. 3 is a diagram related to a “semi-automatic” second embodiment head first vehicle parking system with the driver's “hands on.”

FIG. 4 is a diagram related to a “non-automatic” third embodiment head first vehicle parking with the driver's “hands on.”

FIG. 5 is a graph of headfirst parking assist data showing a “bang-bang stop” control data wherein the rear wheels are steered to a max “bang” turned position and a neutral stop position.

FIG. 6 is a flow chart related to the “non-automatic” third embodiment.

FIG. 7 is a diagram related to the first embodiment.

FIG. 8 is a flow chart related to the first embodiment.

FIG. 9 is a flow chart related to the second embodiment.

### DETAILED DESCRIPTION OF THE PREFERRED EMBODIMENTS

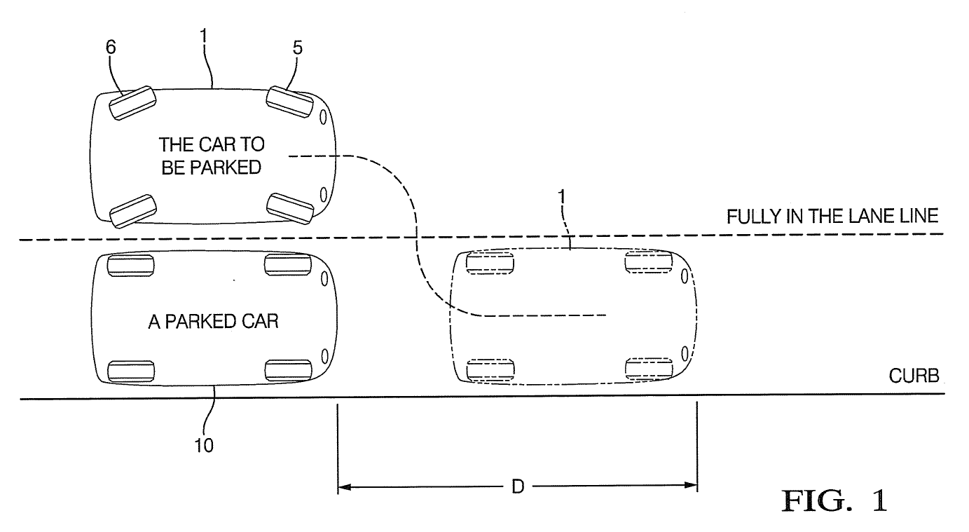

To at least avoid the above-mentioned issues, the present disclosure related to assistance for headfirst parallel parking maneuvers (see FIG. 1) is presented. Equipment which may be used with the embodiments described below may include known rear & front wheel steering systems, and known vision systems. Known vehicle position sensing devices may also be used such as: yaw rate sensors and/or GPS. For example, modern GPS devices may be used and are capable of precisely locating a vehicle to within centimeters.

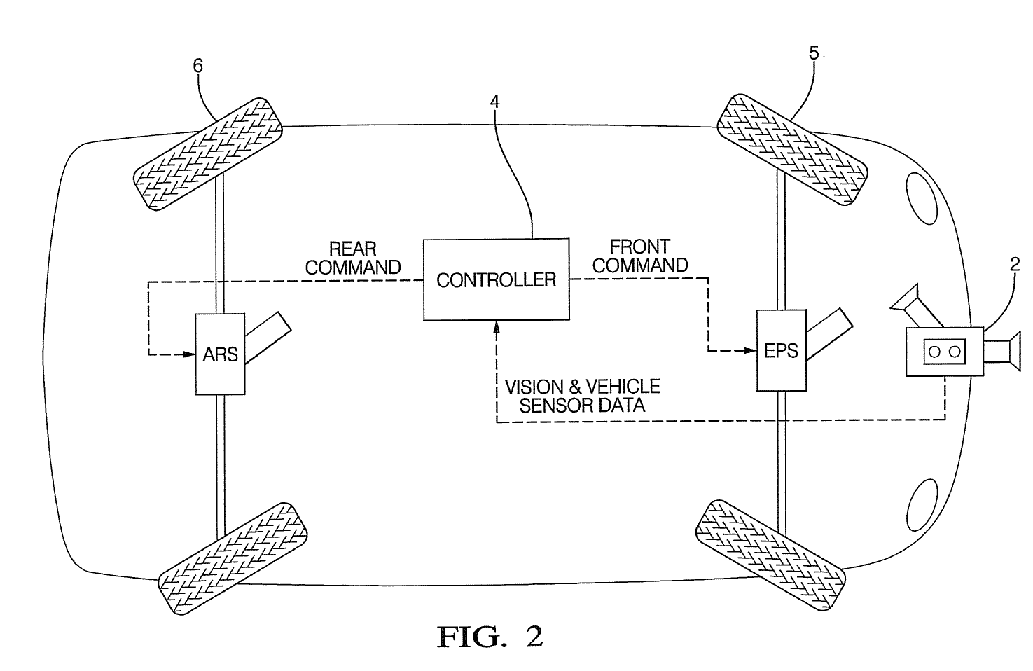

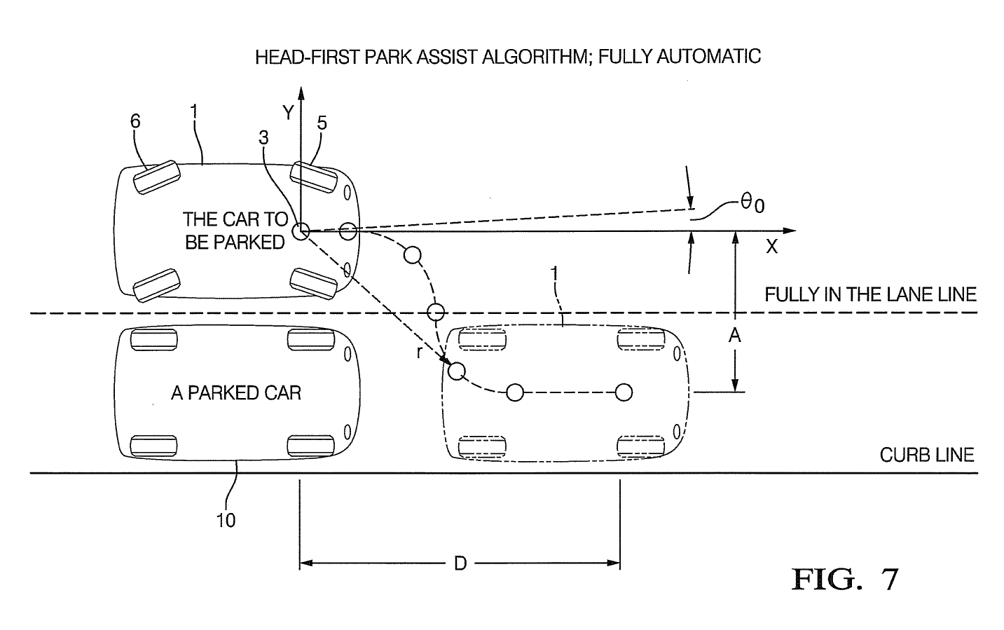

As shown in FIGS. 2 and 7, the first embodiment is termed herein “Fully Automatic” (see FIGS. 2 and 7). This configuration utilizes a vision system 2, vehicle position sensing devices (such as GPS), and is fully automated through the use of Electric Power Steering actuator (EPS) to steer the front wheels and Active Rear Steering Actuator (ARS) to steer the rear wheels.

As is the case with all of the present embodiments, the first embodiment parks the vehicle headfirst. Thus, driver's car 1 needs to be staged at the back of the parking spot alongside a parked car 10 (see FIG. 7) in order to initiate a head first parking maneuver. Thus, the present initial staging sequence is important because the front steering system 5 and the rear steering system 6 have limits so that if for example the car was staged too far forward, the steering systems would not physically be able to steer the vehicle along a proper course and into the parking spot in one headfirst maneuver.

As shown in FIG. 7, during the initial staging of the first embodiment, the driver drives the driver's car 1 alongside parked car 10 and stops. However, it is also envisioned that a slowdown may be all that is necessary in order to perform the functions of staging. The driver may then push a button to activate the automatic parking system, for example. The controller 4 (see FIG. 2) may then check that the proper gear is selected such as “D” for drive on an automatic transmission. Additionally, the controller may check that the brake is applied. If the desired preliminary staging conditions are met, the automatic parking system begins to gather coordinate data to complete the staging process.

Coordinate data may be gathered as follows. A vision system 2 is used to transform the locations of objects such as the parked car 10 and the location of the curb into a suitable coordinate system such as (x, y) coordinates for example (see FIG. 7). Additionally, a predetermined coordinate reference point 3 is used and is located at a known point in the driver's car 1, such as for example the center of gravity(CG) point of the driver's car. This reference point 3 is used to quantify the dimensions of the driver's car 1 in the coordinate system. Thus, the distances from the reference point 3 to other points on the driver's car 1 such as to the front bumper and to the sides, to the front, and to the rear of the driver's car 1 for example are known. These distances are preset in the controller 4 and can be used with actual coordinate location information “r” from a vehicle position sensing device (such as GPS or processed information from yaw rate sensor or the like) and the information from the vision system 2 for example to calculate the desired course of the driver's car 1 in the controller 4. In other words, the controller 4 can determine whether the driver's car 1 will hit the parked car 10 for example or hit other sensed obstacles to parking such as the curb. Thus, the controller 4 plots a course as shown by the dashed line in FIG. 7 accordingly to give the driver's car 1 enough room to clear the parked car 10, while also parking the driver's car 1 relatively close enough to the parked car 10 as a proficient driver could do manually. In other words, the staging is based on the position of the parked car 10, so that when the driver's car 1 is parked, it will be parked about two feet in front of the parked car 10. This will allow the parked car 10 to turn and leave its space, but will not waste parking space. Additionally, once the driver's car 1 is positioned near the curb and in the parking spot, the driver may of course manually increase this final resultant parking distance from the parked car 10 by pulling forward manually if desired. The desired course is also physically and angularly made possible by the rear wheel steering system 6.

Thus in summary, during the staging sequence, the location of the driver's car 1 in relation to the parked car 10 is determined by the controller 4 in a coordinate system using positioning systems such as a GPS and a vision system 2 that can transform and scale visually gathered data to a useful coordinate system such as (x, y) coordinates in order to plot a desired course as shown by the dashed line in FIG. 7.

Specifically, from the vision system 2, as shown in FIG. 7, distance A is determined in the controller 4. As shown, distance A is the y-axis coordinate distance from reference point 3 when staged to the reference point 3 when parked alongside the curb. Additionally, as shown, distance D is determined which is the x-axis coordinate direction from reference point 3 when staged to the reference point 3 when parked alongside the curb.

Also, for example, the heading of the car when set in the staging area is recorded as heading angle θ₀. Thus, if the car when staged is not perfectly aligned to be parallel with the x-axis which is set to be parallel to the curb line for example, the initial heading deviation can be compensated for by the controller 4 before the target course is determined and before the automatic parking begins. In addition to this open loop control, a closed loop control is added to account for minor (but necessary) adjustments to the steerable wheels.

From the data gathered, the controller 4 may generate a target path y during the staging process. For example (see FIG. 7) the following cubic polynomial may be used:

$$y = ( \frac{2 A}{{D}^{3}} + \frac{C}{{D}^{2}} ) {x}^{3} - ( \frac{2 C}{D} + \frac{3 A}{{D}^{2}} ) {x}^{2} + Cx$$

where C=tan(θ₀). This form will satisfy y=0@x=0 & y=−A@x=D, dy/dx=C@x=0 & dy/dx=0@x=D.

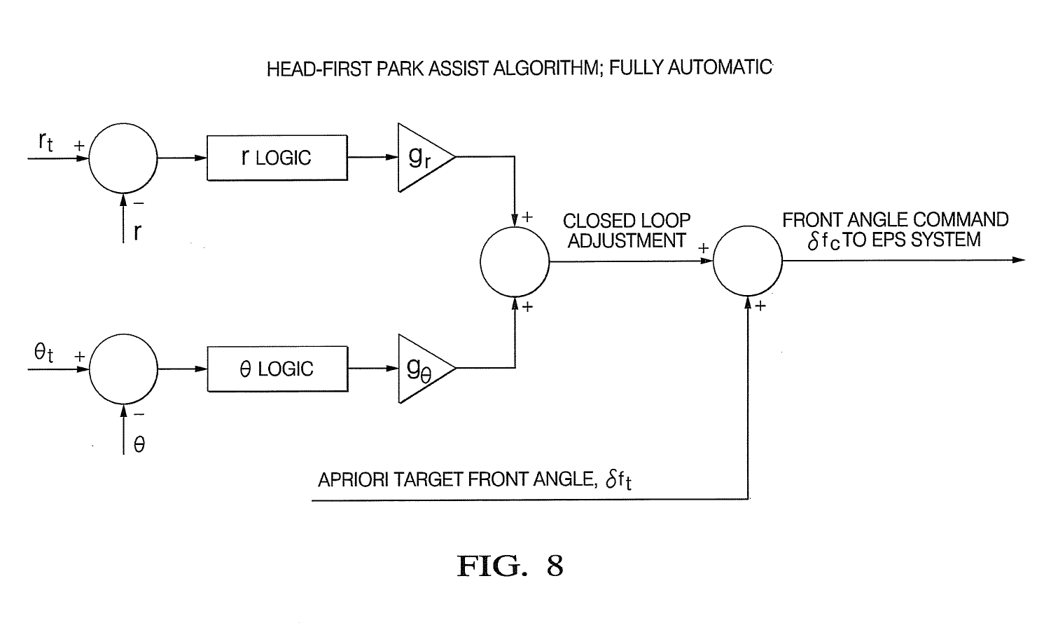

In a traditional car with front steering only, the above target path uniquely corresponds to a (time) profile of the front wheels assuming a given vehicle speed and road conditions. With the advent of steerable rear wheels, however, there could be numerous combinations of front and rear wheel profiles that could achieve the same target path for the vehicle. We will choose to steer the rear wheels in a certain way in relationship to the front wheels. We call this the “bang-bang-stop” approach and we will detail that in our last embodiment. Given this interdependency and the chosen vehicle target path, it would be easy for people skilled in the art to come up with a priori target (or open loop) front angle, δfₜ (see FIG. 8).

Closed loop adjustments to δfₜ can be added based on a real time difference between actual and target positions (r and rₜ, respectively), and between actual and target heading angles (θ and θₜ, respectively). The algorithms “r logic” and “θ logic” would react to these differences. In their simplest forms, these algorithms could be just some fixed gains. More sophisticated algorithms may be employed if a better response time or other features are demanded. Furthermore, weighting gains gᵣ and g_{θ}, are used to put more or less emphasis on position vs. heading. For example, gᵣ=1 and g_{θ}=0 would mean that our closed loop adjustment will come only due to position errors and any heading errors will be ignored. Other calibrations such as gᵣ=0.25 and g_{θ}=0.75 would also be possible. The sum of these closed loop corrections are added to the a priori (open loop) target for the front wheels, δfₜ. The final command to the front wheels is a combination of open and closed loop commands while the rear wheel commands are determined in an open loop fashion.

Alternatively, closed loop action can be assigned to the rear wheels as well. For example, while the r logic adjustments are done for the front wheels the θ logic adjustments can be done by the rear wheels.

Safety procedures can also be implemented. For example, if the vehicle has stopped with too large of an initial heading angle, the system will not attempt to perform the staging or an automatic parking maneuver. Or if the real time errors between actual (or sensed) position and the target position exceeds a certain threshold, the system may abort automatic parking and revert to a manual operation.

The controller 4 determines how many degrees the front steering system 5 and the rear steering system 6 should be turned to in order for the reference point 3 to follow the desired course as shown in the dashed lines of FIG. 7. The system then may alert the driver that it is ready to park for example by sounding a ready tone.

Next, the driver confirms visually that the desired parking spot is sufficient, and starts the automatic parking maneuver by releasing his foot from the brake pedal with the “drive” mode selected on an automatic transmission for example. Now with the driver's hands taken off the steering wheel, the controller 4 actively commands to the front steering system 5 and the rear steering system 6 in order for the driver's car 1 to follow the desired course. The automatic parking maneuver ends when the vehicle is parked in the desired position and the driver puts his foot on the brake pedal. The driver can interrupt the motion at any time by placing his foot on the brake. When the brake is released, the system will continue to attempt to park the driver's car 1 until the reference point 3 reaches the desired position. Thus, the driver can regulate the speed of the maneuver with brake pedal as a safety precaution. The system can also be turned off by pushing the system “on/off” button at any time, or exceeding a preset threshold on the gas or brake pedals.

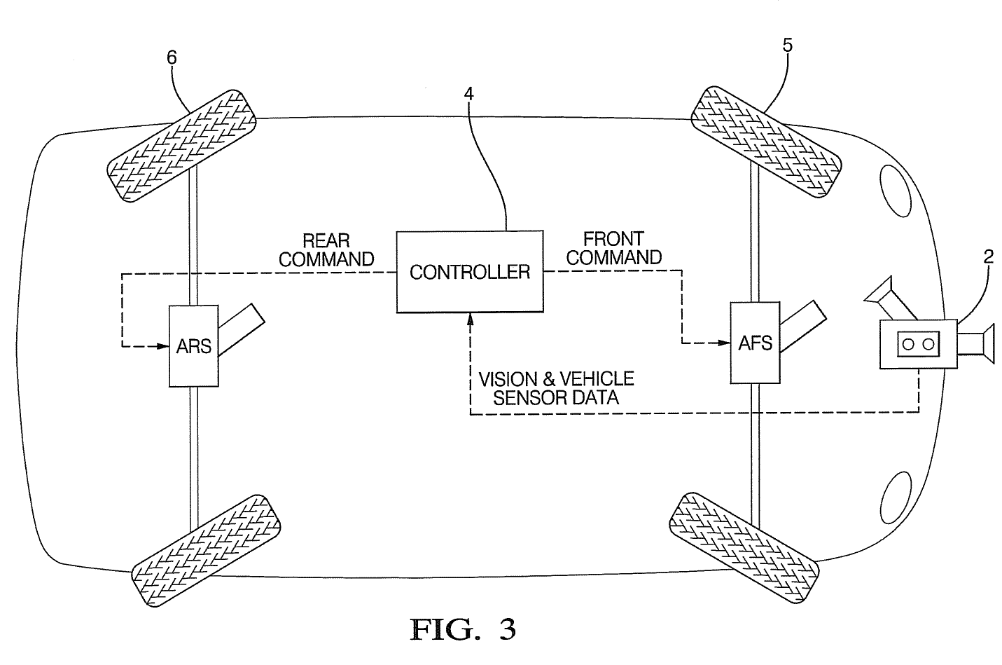

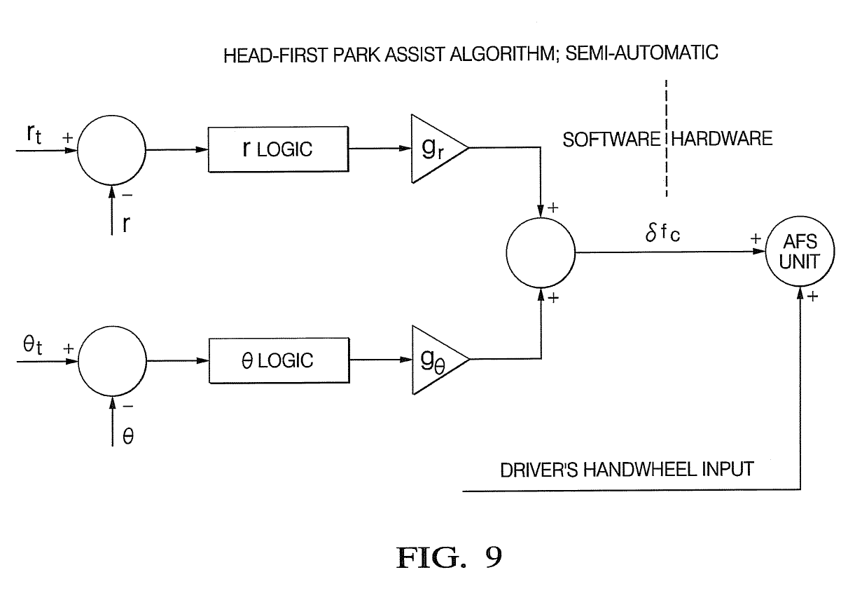

The second embodiment system is termed herein “Semi Automatic” see FIGS. 3 and 9. This configuration is the same as the first embodiment except that the driver is turning the steering wheel throughout the maneuver and the system is making corrections to the driver's inputs based on the desired course as determined during the staging process as in the first embodiment. Thus, this second embodiment uses an Active Front Steering (AFS) system. Minor corrections (per inputs from the vehicle position sensing devices such as GPS and vision system) to the position of the front wheels are still possible. The rear steering system 6 uses an ARS (Active rear steering) actuator controlled by a bang-bang-stop method (to be discussed later). Since both the AFS & ARS systems are reacting to the drivers input, the system while assisting the driver, does not take away the controls from him/her. The correction logic is shown in FIG. 9.

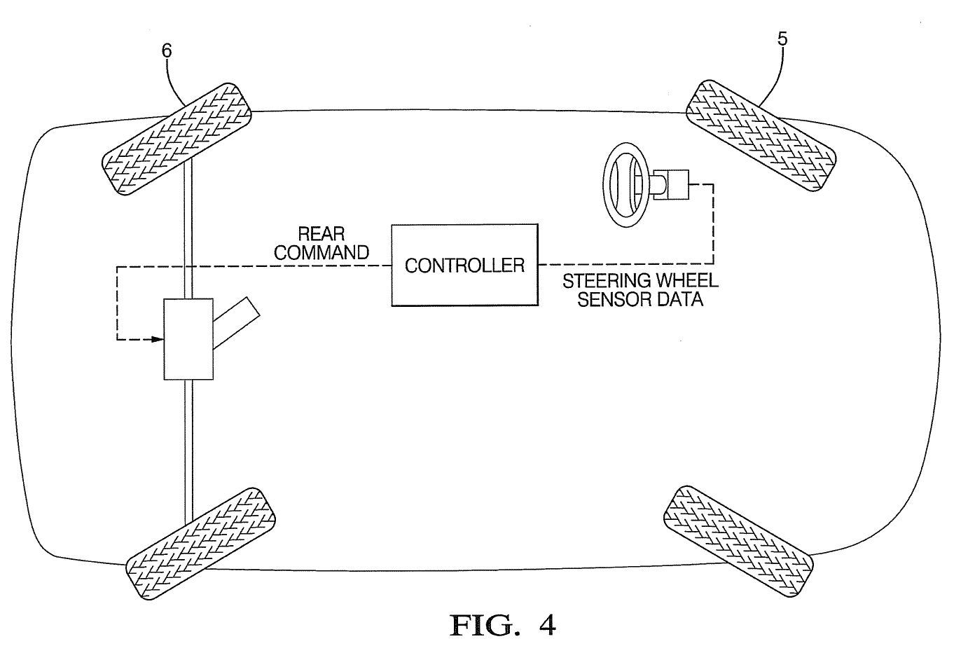

The third embodiment system is termed herein “Non-Automatic” (see FIG. 4). In this configuration the driver is in complete control of front wheels and the front steering system 5 while the rear wheels and the rear steering system 6 are reactive to the motion of steering wheel as sensed by a handwheel angle sensor. The rear wheels can be controlled to be proportional in magnitude and opposite in direction to the front wheels.

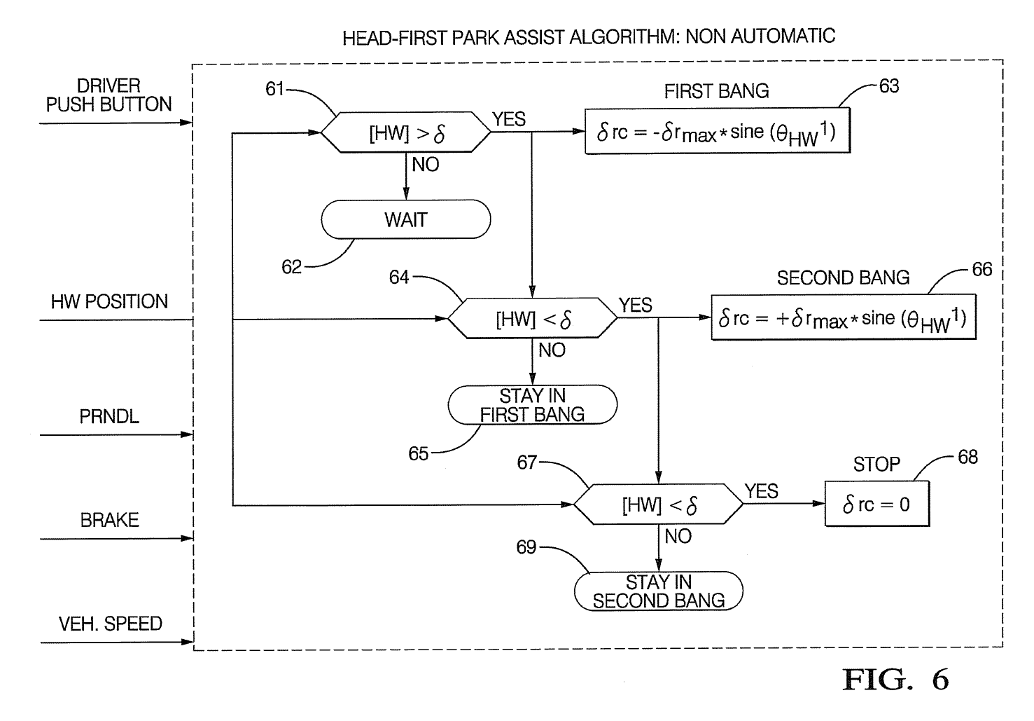

Advantagously, a “bang-bang-stop” control can be provided. In this case, the rear wheels are steered to their maximum or “banged” (opposing the front wheels) and are held at that position while the driver is going to one side of the center steering wheel position. The rear wheels are steered to their maximum or banged in the other direction when the driver turns the steering wheel or handwheel HW passes the centered or neutral position “straight ahead.” If there is a third crossing of the center position by the driver, the rear wheels are best commanded to their zero position. This is shown in logic of FIG. 6 using the following definitions:
δ threshold for Handwheel angle near zero
δrc Rear wheel commanded angle
δrₘₐₓ Maximum Rear wheel angle possible
θ_{HW}¹ Handwheel angle at the start of entrance to the first bang
θ_{HW} Handwheel angle as measured by the handwheel sensor
   Specifically, the bang-bang-stop control sequence operates as follows. The main input to this algorithm is θ_{HW}, or simply HW. Other inputs such as brake/accel, veh speed, PRNDL are shown for completeness sake since they would be needed for a safe operation as per safety/diagnostics discussions in previous embodiments. The sequence of events are from the top to the bottom in the diagram. So, first (i.e. after entrance to Park Assist mode) HW is checked in the first logical block 61 to see if it exceeds the threshold δ. If no, the actuator waits for the driver to move the handwheel beyond the threshold at block 62. If yes (the value of HW corresponding to θ_{HW}¹ is recorded) and the rear wheels are commanded to go to their maximum (i.e. δrc=δrₘₐₓ) in a direction opposite to the initial angle, θ_{HW}¹ at block 63. This is shown in equation labeled 1^{st} bang. In the meantime, the second logical block 64 is continuously checked to see if the driver has brought the steering wheel back to the center as determined by the same threshold. If no, the actuator system remains in the first bang at block 65. If yes, the rear wheels are commanded to go to δrₘₐₓ in the opposite direction at block 66 which contains the equation corresponding to the 2^{nd} bang. Once this has taken place, the system remains in the 2^{nd} bang unit (see block 69) until the 3^{rd} logical block 67 detects that the driver has brought the steering wheel back to center as determined by the threshold, δ. At that point the rear wheels are commanded to their straight positions at block 68 (i.e. δrc=0). This is done because at this point in the maneuver the vehicle is usually parked in the appropriate position and countersteering the rear wheels to their maximum (or less) could be problematic. That is, the last countersteering could bring the back of the car in too far resulting in a car fully within the parking spot but not perfectly parallel to the curb line. The driver may attempt to back up the vehicle which would cause yet another coutersteering of the rear wheels. This could cause a rocking of the car back and fort without much improvement. Therefore, it is best to leave the rear wheels at their straight ahead position during the last segment of the parking maneuver.

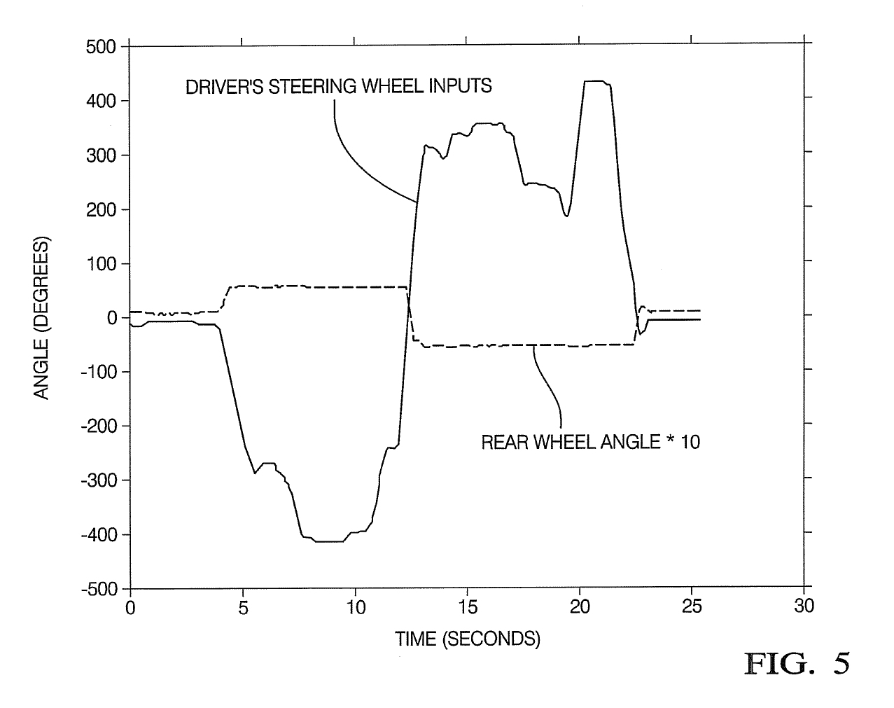

FIG. 5 shows a graphical example of data related to the last embodiment and shows how rear wheels can be commanded during the bang-bang-stop control. Note that the chosen vehicle had a maximum capability of ±5 degrees of rear wheel steering. The distance D (see FIG. 1) was measured each time to show the improvements possible in Heads First Parallel Parking with rear steering. The distance D was shown to be 8.5 yards or more without ARS, and was reduced to 7 yards with ARS (in the bang-bang-stop control). It is believed that it is possible to decrease this distance further with increased rear wheel angulations. Further improvements are also possible if the rear wheels are commanded in an anticipatory way (during the 2^{nd} Bang) compared to the front wheels.

It is also noted that based on a target path such as the thick dashed line in FIG. 7, which shows the determined course (by the controller 4) of reference point 3, and given an assumed constant (tightly controlled) vehicle speed V such as 1, 2, or 3 MPH, for example, it is possible to determine target profiles for rₜ(t) and θₜ(t) so that all of the needed positions of reference point 3 can be predetermined and plotted as a function of time. Therefore, the speed of the vehicle is known and the speed of the vehicle is controlled or monitored by the controller either passively (by the driver putting the transmission in drive and allowing the car to naturally move forward in drive), or actively by the controller actively controlling the throttle and the brakes either mechanically or electronically. Thus, for example, at one second into the parking maneuver, the correct position of reference point 3 is already known for the maneuver before it is attempted. Therefore, corrections can be made during the parking maneuver to align the reference point 3 with target profiles or points on the determined course. Alternatively, these targets can be generated experimentally or by simulation. Based on the above, and assuming a Bang-Bang-Stop rear steering, it is possible to determine the front angle target time profile δfₜ(t). This step too can be done analytically, experimentally, or in simulation.

For safety reasons an embodiment would also incorporate means to limit the maximum vehicle rate or speed in MPH to below 5 MPH such as brake control or throttle control.

The gathering of coordinate data from sensors may be gathered from, but is not limited to: GPS units, vision sensors, yaw rate sensors, inertial sensors, velocity sensors, speed sensors, wheel position sensors, steering angle position sensors, handwheel sensors, geared sensors, steering wheel sensors, radar sensors, lidar sensors, CCD sensors, electrical sensors, mechanical sensors, magnetic sensors, photo sensors, impact sensors, torque sensors or infrared sensors or other suitable sensors.

The course determined by the controller (see “r” in FIG. 7) may also be plotted and displayed in any display format, for example as in FIG. 7, to a user on an in vehicle LCD screen for example for confirmation before parking is attempted.

The capabilities of the present invention may be implemented in software, firmware, hardware or some combination thereof. As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the invention.

While the preferred embodiment to the invention has been described, it will be understood that those skilled in the art, both now and in the future, may make various improvements and enhancements which fall within the scope of the invention.

What is claimed is:

1. A controller assisted method for headfirst parallel parking of a vehicle equipped with four-wheel steering comprising:
gathering coordinate data from sensors which indicate the location of the vehicle, the location of an available parallel parking space, and the locations of obstacles;
determining via a controller a course that the vehicle should follow in order to parallel park the vehicle in a headfirst forward direction; and
controlling via the controller at least one of a front steering system of the vehicle and a rear steering system of the vehicle so that the at least one steering system directs the vehicle to follow the course in a headfirst direction.

2. The method of claim 1 wherein the gathering coordinate data further comprises:
staging the vehicle before entering an available parallel parking space.

3. The method of claim 1 wherein the controlling via the controller further comprises a fully automatic mode wherein the controller actively turns a steering wheel of the vehicle via the steering systems so that a user does not have to manually control or touch the steering wheel.

4. The method of claim 1 wherein the controlling via the controller further comprises a semi-automatic mode wherein the controller actively corrects a user's manual turning of a steering wheel of the vehicle via the steering systems so that the user's manual inputs to the steering wheel are actively corrected to be on the course determined by the controller.

5. The method of claim 1 wherein the controlling via the controller further comprises a non-automatic mode wherein the controller only actively controls the rear wheel steering system to be reactive to manual turning of a steering wheel of the vehicle.

6. The method of claim 1 wherein the rear steering system is set to function in a bang-bang-stop mode wherein the rear wheels are turned from a first extreme position in opposition to the position of the front wheels to a second opposite extreme position in opposition to the position of the front wheels when a steering wheel of the vehicle passes a neutral or centered position.

7. The method of claim 1 wherein the controlling via the controller further comprises implementation of a closed loop feedback step to further adjust and correct the determined course via the controller as the vehicle parks.

8. The method of claim 1 wherein the gathering coordinate data from sensors is gathered from group consisting of: GPS units, vision sensors, yaw rate sensors, inertial sensors, velocity sensors, speed sensors, wheel position sensors, steering angle position sensors, handwheel sensors, geared sensors, steering wheel sensors, radar sensors, lidar sensors, CCD sensors, electrical sensors, mechanical sensors, magnetic sensors, photo sensors, impact sensors, torque sensors, or infrared sensors.

9. The method of claim 4 wherein the controlling via the controller a front steering system of the vehicle and a rear steering system of the vehicle further comprises use of Active Front Steering (AFS) and an Active Rear Steering (ARS).

10. The method of claim 1 wherein the course is plotted and displayed to a user for confirmation before parking is attempted.

11. An apparatus for headfirst parallel parking for use with a vehicle equipped with front and rear wheel steering systems comprising:
sensors for gathering coordinate data which indicate the location of the vehicle, the location of an available parallel parking space, and the locations of obstacles;
a controller for determining a course that the vehicle should follow in order to parallel park the vehicle in a headfirst forward direction wherein the controller controls at least one of the front and rear wheel steering systems of the vehicle so that the at least one steering system directs the vehicle to follow the course determined in a headfirst direction.

12. The apparatus of claim 11 wherein the controller comprises:
a fully automatic controller mode wherein the controller controls the vehicle and actively turns a steering wheel of the vehicle via the steering systems so that a user does not have to manually control or touch the steering wheel.

13. The apparatus of claim 11 wherein the controller comprises:
a semi-automatic controller mode wherein the controller actively corrects a user's manual turning of a steering wheel of the vehicle via the steering systems so that the user's manual inputs to the steering wheel are actively corrected to be on the course determined by the controller.

14. The apparatus of claim 11 wherein the controller comprises:
a non-automatic controller mode wherein the controller only actively controls the rear wheel steering system to be reactive to manual turning of a steering wheel of the vehicle.

15. The apparatus of claim 11 wherein the rear steering system is structured for a bang-bang-stop mode wherein the rear wheels are turned from a first extreme position in opposition to the position of the front wheels to a second opposite extreme position in opposition to the position of the front wheels when the steering wheel of the vehicle passes a neutral or centered position.

16. The apparatus of claim 11 wherein the controller further comprises a closed loop feedback circuit to further adjust and correct the determined course in the controller as the vehicle parks based on input from the sensors.

17. The apparatus of claim 11 wherein the sensors are taken from group consisting of: GPS units, vision sensors, yaw rate sensors, inertial sensors, velocity sensors, speed sensors, wheel position sensors, steering angle position sensors, handwheel sensors, geared sensors, steering wheel sensors, radar sensors, lidar sensors, CCD sensors, electrical sensors, mechanical sensors, magnetic sensors, photo sensors, impact sensors, torque sensors, or infrared sensors.

18. The apparatus of claim 13 wherein the front steering system of the vehicle and the rear steering system of the vehicle further comprises an Active Front Steering (AFS) and an Active Rear Steering (ARS).

19. The apparatus of claim 11 wherein the course is plotted and displayed to a user on a display for confirmation before parking is attempted.

20. A computer readable medium with instructions thereon which cause a processor in a vehicle having front and rear steering systems to perform:
gathering coordinate data from sensors which indicate the location of the vehicle, a location of an available parallel parking space, and locations of obstacles to parking;
determining via a controller a course that the vehicle should follow in order to parallel park the vehicle in a headfirst forward direction; and
controlling via the controller at least one of the front steering system of the vehicle and the rear steering system of the vehicle so that the at least one steering system directs the vehicle to follow the course in a headfirst direction.
